(19) United States
(12) Patent Application Publication
(10) Pub. No.: US 2007/0179001 A1
(43) Pub. Date: Aug. 2, 2007

(54) Tensioner for chain or belt drives

(75) Inventors: Dirk Sass, Hirschald (DE); Christian Riel, Seubersdorf (DE); Holger Kraus, Drosendorf (DE); Brandon Glass, Royal Oak, MI (US); Michael Bogner, Eckental (DE); Martin Assel, Burgbernheim (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Schaeffler KG, Herzogenaurach (DE)

(21) Appl. No.: 11/437,020

(22) Filed: May 18, 2006

Related U.S. Application Data
(60) Provisional application No. 60/682,636, filed on May 19, 2005.

(51) Int. Cl. F16H 7/08; F16H 7/22

(52) U.S. Cl. 474/109; 474/110

(57) ABSTRACT

A tensioning device for chain or belt drives, with a cylindrical tensioner housing (33), whose inner surface is constructed as a guide bore (34), in which a piston (35) is guided, with a compression spring (37) acting on the piston, which can move axially in the chain tensioning direction, and with a latch system (39) limiting the return stroke of the piston (35) in the tensioner housing (33). An additional elastic element, which acts in the axial direction and on which the tensioner housing (33) is supported, is arranged in front of or behind the tensioner housing (33). The additional elastic element is formed by a second compression spring (46) arranged in an additional cylindrical housing (48), with the tensioner housing (33) being inserted into the additional cylindrical housing (48) from one end.

### FIELD OF THE INVENTION

The invention relates to a tensioning device for chain or belt drives, with a cylindrical tensioner housing, whose inner surface is constructed as a guide bore, in which a piston is guided, with a compression spring applying a force to this piston, which can move axially in the chain tensioning direction, and with a latch system limiting the return stroke of the piston in the tensioner housing.

### BACKGROUND OF THE INVENTION

A tensioning device of this type is used primarily for tensioning tensile drives, such as belts or chains, in internal combustion engines. Here, both tensioning devices working with a hydraulic medium and also so-called mechanical chain tensioners are known.

Publication DE 36 36 918 A1 and the corresponding U.S. Pat. No. 4,772,251 show a tensioning device of the type noted above, which works with motor oil as the hydraulic medium. This motor oil is led via an oil pressure connection of the tensioner housing and an opening of the piston into the interior of the piston and from there via a non-return valve, which is arranged between the compression spring and the piston, into a high-pressure chamber of the tensioner housing. At this position is also the compression spring. Because the oil can discharge from the high-pressure chamber only through the leakage gap, which is formed by the tensioner housing and the piston, a damping effect on the piston motion is exerted when the tensioner is in operation.

From publication DE 39 22 037 A1 and the corresponding U.S. Pat. No. 4,985,009, a tensioning device with a latch system constructed on the tensioner housing and the piston and a non-return valve for hydraulic medium is also known. Here, however, the overpressure piston of the non-return valve is not supported directly, but instead through a second compression spring on the damping piston.

Publication DE 296 10 404 U1 shows a mechanical tensioning device, in which a piston or tensioning plunger is supported by means of a first compression spring on the base of a hollow cylindrical tensioner housing. Here, a friction ring, which is supported axially by means of a second compression spring on the base of the tensioner housing, is provided as a damping element. With a crowned outer surface, the friction ring contacts the inner surface of the housing wall. On its end in the housing, the tensioning plunger has an external cone, with which it contacts an internal cone of the friction ring and is supported there axially.

### SUMMARY OF THE INVENTION

The invention is based on the objective of creating a tensioning device, which has a simple construction, which limits the return stroke of the piston in the tensioner housing, and for which a supply of hydraulic medium, such as oil, can be eliminated.

This objective is met according to the invention in that in front of or behind the tensioner housing, there is an additional elastic element, which acts in the axial direction and on which the tensioner housing is supported. The additional elastic element can be formed by a second compression spring arranged in another cylindrical housing, with the tensioner housing being inserted into the other cylindrical housing from one end. The second compression spring can be stiffer than the first compression spring in the tensioner housing.

The second compression spring can be constructed as a helical compression spring, as well as with one end being supported on a base of the tensioner housing and with the other end being supported on a base of the additional cylindrical housing. The latch system can be formed by several latch grooves, which are machined on the guide bore in the tensioner housing, which are arranged axially one behind the other, and which are constructed as peripheral grooves, a spring-mounted stop ring movable in each of these grooves, as well as a lock groove on the outer periphery of the piston for holding the stop ring. In this way, the latch grooves can each have inclined surfaces so the stop ring can slide along these surfaces.

The additional elastic element is compressed only when the piston of the tensioning device in the tensioner device falls to the next latch groove and the force applied by the chain or belt drive rises further. Through the flexibility due to the additional element, peak forces in the drive are eliminated. This stands in contrast to previously known tensioning devices with latch systems, which limits the return stroke of the piston “inflexibly,” from which high peak forces (loads) can result in the drive.

### BRIEF DESCRIPTION OF THE DRAWING

One embodiment of the invention is shown in the drawing and described in more detail below. Shown are:

FIG. 1 a longitudinal section view of a tensioning device according to the invention;

FIG. 2 a longitudinal section view of a previously known tensioning device.

### DETAILED DESCRIPTION OF THE DRAWING

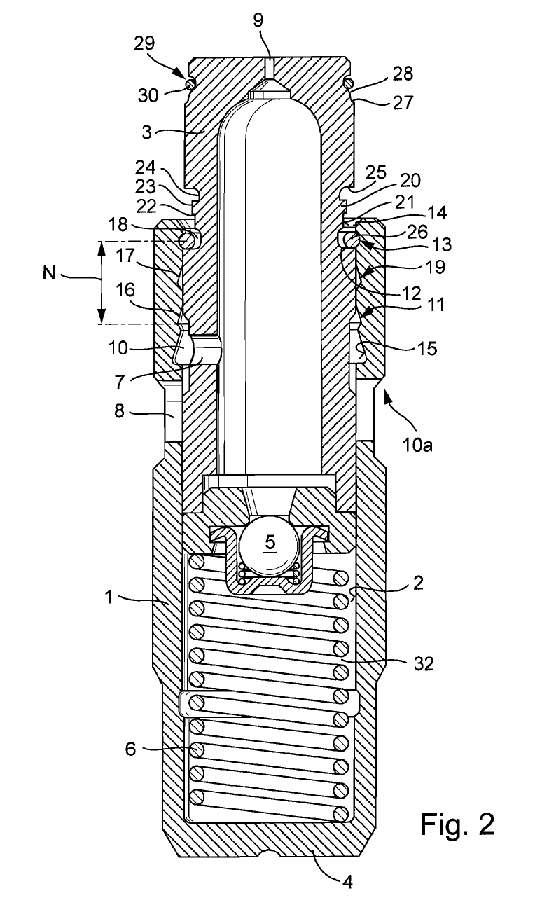

The previously known tensioning device shown in FIG. 2 contains a circular cylindrical housing 1. This is open on one side and has a base, as well as a guide bore 2. A hollow piston 3, which acts as a damping piston, because this tensioning device is constructed as a hydraulic tensioner, that is, it works with oil as the hydraulic medium, is inserted into the guide bore. On the side of the piston 3 facing the base 4 of the housing 1, there is a non-return valve 5. Between the base 4 and the non-return valve 5 there is a compression spring 6 acting on the piston 3. On the side of the piston 3 there is an opening 7, which connects to an oil pressure connection 8 of the housing 1. An opening 9 on the head of the piston 3 is used for venting.

A holding groove 10, three equal latch grooves 11, 12, and 13, and also an insertion incline 14 are constructed axially one behind the other on the inner periphery of the housing 1. They are features of a latch system 10a of the tensioning device formed by the housing 1 and the piston 3. The diameter of the holding groove 10 is greater than the diameter of the latch groove 11. The holding groove 10 has an inclined surface 15 relative to the latch groove 11. The latch grooves 11 and 12 are provided with corresponding inclined surfaces 16 and 17.

A lock groove 18, which is limited on one side by a stop edge 19 and on the other side by a stop ramp 20, is constructed on the outer periphery of the piston 3. The stop ramp 20 has a locking surface 21, a stop edge 22, and a passage surface 23. An insert groove 24 with an insert edge 25 connects to the stop ramp 20. The outer diameters of the stop edge 19 and the insert edge 25 correspond to the outer diameter of the piston 3. The diameter of the passage surface 23 is smaller. A spring-mounted stop ring 26 is allocated to the mentioned circular grooves or channels of the housing 1 and the piston 3. A groove 29, which is provided with a latch surface 27 and an inclined surface 28 and to which is allocated an assembly ring 30, is constructed on the outside of the piston 3. After the installation of the chain and optionally a transmission element provided between the piston 3 and the chain, at the beginning of operation of the tensioning device, the stop ring 26 is located in the holding groove 10 and expands due to its spring force, so that it contacts the base of the holding groove 10.

Under the effect of the compression spring 6, the piston 3 moves in the chain tensioning direction. The stop edge 19 contacts the stop ring 26 and pushes this over the inclined surface 15 in the direction of the first latch groove 11. The stop ring 26 then snaps into the latch groove 11. This position is the beginning of the chain tensioning region.

Oil pressure is built up via the oil pressure connection 8 via the non-return valve 5 in the housing 1 between this valve and the piston 3 in the high-pressure chamber 32 located there. For impact loading of the chain, a force acts on the piston 3 in the direction towards the housing 1. This leads to a return motion of the piston 3 against the direction of force of the compression spring 6. The return motion is damped by the oil pressure in the high-pressure chamber 32 of the housing 1. In the return motion, the locking surface 21 reaches under the stop ring 26 lying in the latch groove 11. It prevents the stop ring 26 from being pressed together and guarantees that it remains on the base of the latch groove.

The return motion of the piston 3 is limited. The maximum return stroke is determined by the distance of the stop edge 19 from the stop edge 22 and the diameter of the circular cross section of the stop ring 26 and equals, for example, 2 mm. Limiting the return stroke prevents the chain to be tensioned from jumping over teeth of the gears to be driven during impact loading.

If the chain lengthens during operation, for example, due to the appearance of wear, the piston 3 can be pushed further in the direction from the housing 1 under the effect of the compression spring 6, with its stop edge 19 pushing the stop ring 26 over the incline 16 of the latch groove 11 into the next latch groove 12. If the stop ring 26 is led into the latch groove 12, then the above applies for the maximum return stroke. Finally, the stop ring 26 reaches the latch groove 13. Also in this outermost latch position, the piston 3 can run back only by the maximum return stroke. The usable stroke N of the piston 3 determining the chain tensioning region equals, for example, 23 mm.

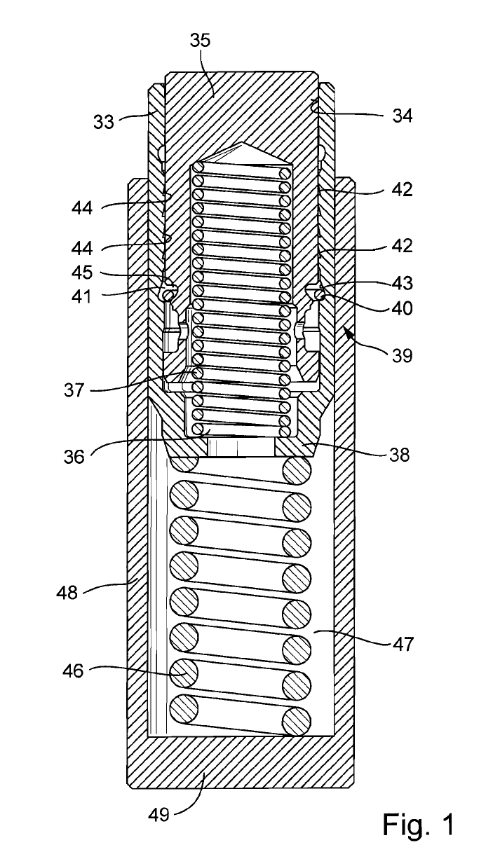

For a tensioning device according to the invention shown in FIG. 1, a piston 35 is inserted into a guide bore 34 of a cylindrical tensioner housing 33. One end of the piston 35 projecting out of the tensioner housing 33 is provided for acting on a chain or belt drive to be tensioned. For this purpose, a first compression spring 37, which is supported with one end on the piston 35 and with the other end on a base 38 of the tensioner housing 33, is located in a hollow chamber 36 of the piston 35. Due to the spring force of the compression spring 37, the piston 35 can move partially out of the tensioner housing 33 in the axial direction.

In order to limit the return stroke for the return motion of the piston 35 in the tensioner housing 33, the tensioning device has a latch system 39, which is formed by the tensioner housing 33 and the piston 35. This can have the same construction and the same effect as the latch system 10a described for FIG. 2. Thus, a latch groove 41 constructed as a holding groove for a spring-mounted stop ring 40 and several other latch grooves 42 are arranged one behind the other in the axial direction on the inner surface of the tensioner housing 33. Inclined surfaces 43 and 44 are allocated to these grooves. The stop ring 40 can slide along these surfaces. On the outer surface of the piston 35 there is a locking groove 45 for the contact of the stop ring 40.

According to the invention, a second compression spring 46, which is supported with its top end on the base 38 of the tensioner housing 33, is arranged as an additional elastic element axially below the tensioner housing 33 in FIG. 1. It is located in the hollow space 47 of another cylindrical housing 48, in which the tensioner housing 33 is inserted up to a portion of its length at the end. With its bottom end, the second compression spring 46 is supported on a base 49 of the other cylindrical housing 48, which is located on the bottom end of the housing 48 facing away from the tensioner housing 33.

### List of Reference Symbols

1 Circular cylindrical housing
2 Guide bore
3 Piston
4 Base
5 Non-return valve
6 Compression spring
7 Opening
8 Oil pressure connection
9 Opening
10 Holding groove
10a Latch system
11 Latch groove
12 Latch groove
13 Latch groove
14 Insertion incline
15 Inclined surface
16 Inclined surface
17 Inclined surface
18 Locking groove
19 Stop edge
20 Stop ramp
21 Locking surface
22 Stop edge
23 Passage surface
24 Insert groove
25 Insert edge
26 Stop ring
27 Latch surface
28 Inclined surface
29 Groove
30 Assembly ring
32 High-pressure chamber
33 Tensioner housing
34 Guide bore
35 Piston
36 Hollow space
37 First compression spring
38 Base of the tensioner housing
39 Latch system
40 Stop ring
41 Latch groove
42 Latch groove
43 Inclined surface
44 Inclined surface
45 Locking groove
46 Second compression spring
47 Hollow space
48 Additional cylindrical housing
49 Base of the additional housing

1. Tensioning device for chain or belt drives, comprising a cylindrical tensioner housing, having an inner surface constructed as a guide bore, in which a piston is guided, with a compression spring applying a force on the piston, which can move axially in a chain tensioning direction, and with a latch system limiting a return stroke of the piston in the tensioner housing, an additional elastic element, which acts in an axial direction and on which the tensioner housing is supported, is arranged in front of or behind the tensioner housing.

2. Device according to claim 1, wherein the additional elastic element is formed by a second compression spring arranged in an additional cylindrical housing, wherein the tensioner housing is inserted into the additional cylindrical housing from one end.

3. Device according to claim 2, wherein the second compression spring is constructed as a helical compression spring, with one end supported on a base of the tensioner housing and with an other end supported on a base of the additional cylindrical housing.

4. Device according to claim 2, wherein the second compression spring is stiffer than the first compression spring located in the tensioner housing.

5. Device according to claim 1, wherein the latch system is formed by several latch grooves which are machined on the guide bore in the tensioner housing, and are arranged axially one behind the other, and which are constructed as peripheral grooves, a spring-mounted stop ring moves in one of the grooves, and a locking groove is arranged on an outer periphery of the piston for holding the stop ring.

6. Device according to claim 5, wherein the latch grooves each have inclined surfaces so that the stop ring can slide along the inclined surfaces.
